(19) United States
(12) Patent Application Publication
(10) Pub. No.: US 2004/0249490 A1
(43) Pub. Date: Dec. 9, 2004

(54) Multichannel audio system, and head unit and slave unit used for the same

(75) Inventor: Kenji Sakai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/833,310

(22) Filed: Apr. 28, 2004

(30) Foreign Application Priority Data
Jun. 6, 2003 (JP) 2003-162639

(51) Int. Cl. G06F 17/00

(52) U.S. Cl. 700/94; 381/77

(57) ABSTRACT

A multichannel audio system is provided which is suitable for optimally utilizing a plurality of amplifiers on a network for multichannel reproduction. It includes a head unit and slave units interconnected with each other via a network. The head unit assigns a channel and transmits multichannel data to each of the slave units. The slave units each generate an audio signal in response to data of the channel assigned by the head unit, the data being extracted from the received multichannel data received from the head unit.

### BACKGROUND OF THE INVENTION

1. Field of the Invention

The present invention relates to a multichannel audio system, and a head unit and slave unit used for the same, and particularly to a technique of carrying out multichannel reproduction using a plurality of audio units.

2. Description of Related Art

Conventionally, an AV (Audio Video) system has been known which corresponds to a multichannel audio system, and includes a plurality of AV units interconnected through a network (see, Relevant Reference 1, for example). In the AV system, the AV units are each composed of functional modules such as a monitor, an amplifier, a tuner and a speaker, and are interconnected via a serial bus that is based on a digital interface like IEEE 1394 standard, and provides the individual AV units with equivalent transmission opportunities periodically by a packet communication method.

The AV system is configured such that the individual AV units can share the functional modules freely. For example, the audio signal of a DVD video player can be transmitted to another amplifier unit via the network to be amplified and output by the amplifier unit. The configuration can increase the resource efficiency of the individual AV units at an internal circuit level, and simplify the wiring and operation between the AV units.

Relevant Reference 1: Japanese patent application laid-open No. 9-130716.

The conventional AV system with the foregoing configuration has a problem in that even though an AV unit includes a plurality of amplifiers, for example, it can carry out only the operation of that module only. For example, a monaural amplifier can output only a monaural signal, and a stereo amplifier can output only a stereo signal. Accordingly, the AV system has a problem of being unable to carry out the 5.1 channel surround reproduction, one of the typical multichannel reproduction, without a 5.1 channel amplifier even if it includes the total of six channels of monaural and stereo amplifiers.

### SUMMARY OF THE INVENTION

The present invention is implemented to solve the foregoing problem. It is therefore an object of the present invention to provide a multichannel audio system and a head unit and slave unit used for the same capable of making effective use of a plurality of amplifiers on a network for multichannel reproduction optimally.

According to an aspect of the present invention, there is provided a multichannel audio system including a head unit and slave units interconnected via a network, wherein the head unit assigns a channel and transmits multichannel data to each of the slave units; and the slave units each generate an audio signal in response to data of a channel assigned by the head unit, the data of the channel being extracted from the multichannel data received from the head unit.

Here, the head unit may include: a sound source for generating multichannel data; a network interface for transmitting the multichannel data generated by the sound source to the network; a channel decider for assigning the channel to each of the slave units and to the head unit which are connected to the network; a channel extractor for extracting data of the channel assigned by the channel decider from the multichannel data generated by the sound source; and an amplifier for amplifying the extracted channel signal obtained by the channel extractor.

The slave units may each include: a channel extractor for extracting data of the preassigned channel from the multichannel data transmitted from the network; and an amplifier for amplifying an extracted channel signal obtained by the channel extractor.

Thus, the multichannel audio system can reproduce a multichannel sounds using a plurality of slave units. As a result, it can carry out multichannel reproduction efficiently by utilizing monaural and/or stereo amplifiers without amplifiers for the multichannel reproduction.

### BRIEF DESCRIPTION OF THE DRAWINGS

FIG. 1 is a diagram showing a schematic configuration of an embodiment 1 of a multichannel audio system in accordance with the present invention;

FIG. 2 is a block diagram showing a detailed configuration of the DVD player of FIG. 1;

FIG. 3 is a block diagram showing a detailed configuration of a part of the minicomponent stereo of FIG. 1;

FIG. 4 is a flowchart illustrating the operation of the embodiment 1 of the multichannel audio system in accordance with the present invention;

FIG. 5 is a flowchart illustrating the reproduction channel establishment processing in FIG. 4;

FIG. 6 is a block diagram showing a configuration of an embodiment 2 of a multichannel audio system in accordance with the present invention;

FIG. 7 is a block diagram showing a detailed configuration of a part of the minicomponent stereo of the embodiment 2;

FIG. 8 is a flowchart illustrating the reproduction channel establishment processing of the embodiment 2; and

FIG. 9 is a diagram showing an application of the embodiment 1 or 2 of the multichannel audio system in accordance with the present invention.

### DETAILED DESCRIPTION OF THE PREFERRED EMBODIMENTS

The invention will now be described with reference to the accompanying drawings. The following description is made by way of example using the 5.1 channels as the multichannel.

Embodiment 1

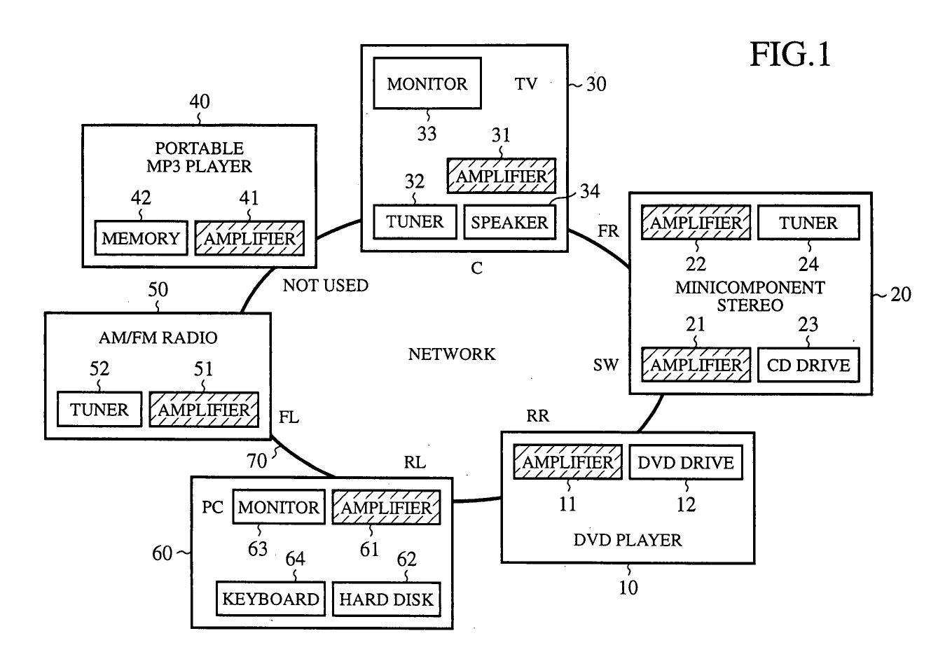

FIG. 1 is a schematic diagram showing a configuration of an embodiment 1 of the multichannel audio system in accordance with the present invention. The multichannel audio system consists of a plurality of units interconnected via a network 70. The units each include an audio amplifier (simply called “amplifier” from now on), and consist of a DVD (digital video disk) player 10, a minicomponent stereo 20, television set (abbreviated to “TV set” from now on) 30, a portable MP3 player 40, an AM/FM radio 50 and a personal computer (abbreviated to “PC” from now on) 60.

The network 70 can be composed of a LAN (Local Area Network). The individual units exchange audio data (called “multichannel data” from now on) for the 5.1 channel reproduction with each other via the network 70. The individual units carry out the monaural reproduction or stereo reproduction independently when they do not perform the 5.1 channel reproduction.

During the 5.1 channel reproduction in the present embodiment 1, the DVD player 10 operates as a head unit, and the other units operate as slave units. The head unit refers to the unit that controls the entire system, and transmits the multichannel data for the 5.1 channel reproduction generated by a sound source to the slave units. The slave unit refers to the unit that operates under the control of the head unit, and reproduces the audio signal in response to the multichannel data received from the head unit.

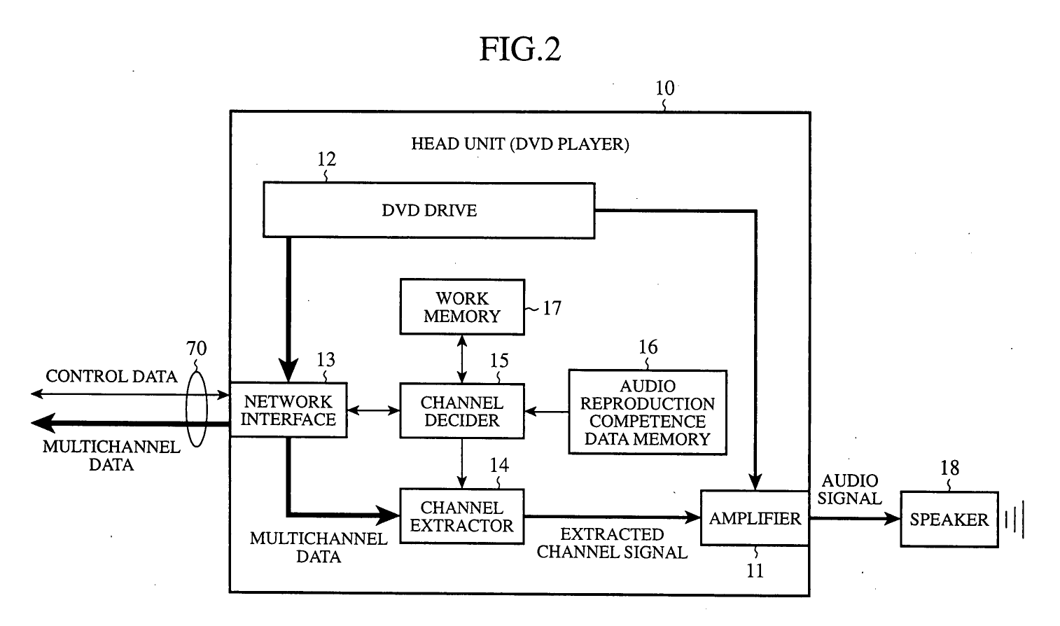

The DVD player 10 includes an amplifier 11 and a DVD drive 12. The DVD player 10 generates a video signal and an audio signal in response to the data read from a DVD (not shown) inserted into the DVD drive 12 when it does not carry out the 5.1 channel reproduction. The video signal generated by the DVD player 10 is transmitted to a monitor not shown, and the audio signal is amplified by the amplifier 11 and delivered to a speaker 18 (see FIG. 2).

In contrast, when carrying out the 5.1 channel reproduction, the DVD player 10 performs the reproduction channel establishment processing that assigns channels to all the units connected to the network 70, including the DVD player 10 itself. A configuration is also possible which does not assigns a channel to the head unit (the DVD player 10 in the present embodiment 1), in which all the audio signals of the individual channels are generated by the slave units only.

In FIG. 1, an internal amplifier 31 of the TV set 30 is assigned for the center (C), an internal amplifier 51 of the AM/FM radio 50 is assigned for the front left (FL), and an internal amplifier 22 of the minicomponent stereo 20 is assigned for the front right (FR). In addition, an internal amplifier 61 of the PC 60 is assigned for the rear left (RL), an internal amplifier 11 of the DVD player 10 is assigned for the rear right (RR), and a second internal amplifier 21 of the minicomponent stereo 20 is assigned for the sub-woofer (SW). An internal amplifier 41 of the portable MP3 player 40 is not assigned to any channel (not used).

During the 5.1 channel reproduction, the DVD player 10 reads the multichannel data from the DVD inserted into the DVD drive 12, and transmits the data to the network 70. In addition, the DVD player 10 extracts the data of the channel assigned thereto, generates the audio signal, and supplies it to the amplifier 11. The amplifier 11 amplifies the audio signal, and supplies it to the speaker 18 (see, FIG. 2), thereby generating the rear right (RR) sounds. The detail of the DVD player 10 will be described later.

The minicomponent stereo 20 includes the amplifier 21, the amplifier 22, a CD drive 23 and a tuner 24. When not performing the 5.1 channel reproduction, the minicomponent stereo 20 generates the audio signal in response to the data read from a CD (not shown) inserted into the CD drive 23, and supplies the signal to the amplifier 21. In addition, it generates an audio signal in response to a signal received from the tuner 24, and transfers the audio signal to the amplifier 22.

On the other hand, to perform the 5.1 channel reproduction, the minicomponent stereo 20 extracts two-channel data assigned to itself from the multichannel data sent from the network 70, generates two audio signals from the two-channel data, and supplies them to the amplifiers 21 and 22. The audio signals amplified by the amplifiers 21 and 22 are supplied to the speakers not shown, thereby producing the sounds for the sub-woofer (SW) and front right (FR).

The TV set 30 includes the amplifier 31, a tuner 32, a monitor 33 and a speaker 34. When not performing the 5.1 channel reproduction, the TV set 30 generates the video and audio signals in response to a signal fed from the tuner 32, and supplies them to the amplifier 31. The amplifier 31 amplifies the received video signal and supplies it to the monitor 33. It also amplifies the received audio signal and supplies it to the speaker 34. Thus, the monitor 33 displays the video, and the speaker 34 produces sounds.

On the other hand, to perform the 5.1 channel reproduction, the TV set 30 extracts the data of the channel assigned to itself from the multichannel data transmitted via the network 70, generates the audio signal in response to the data of the channel extracted, and supplies it to the amplifier 31. The amplifier 31 amplifies the audio signal and supplies it to the speaker 34, thereby producing the sounds for the center (C).

The portable MP3 player 40 includes the amplifier 41 and a memory 42. When not performing the 5.1 channel reproduction, the portable MP3 player 40 generates the audio signal in response to the data stored in the memory 42, and supplies it to the amplifier 41. The amplifier 41 amplifies the audio signal, and supplies it to the speaker not shown, thereby producing sounds from the speaker.

On the other hand, to perform the 5.1 channel reproduction, the portable MP3 player 40 extracts the data of the channel assigned to itself from the multichannel data transmitted via the network 70, reproduces the audio signal in response to the data of the extracted channel, and supplies it to the amplifier 41. The amplifier 41 amplifies the audio signal, and supplies it to the speaker not shown, thereby producing sounds. Incidentally, in the example as shown in FIG. 1, since the portable MP3 player 40 is not used as a unit in the multichannel audio system, it does not operate during the 5.1 channel reproduction.

The AM/FM radio 50 includes the amplifier 51 and a tuner 52. When not performing the 5.1 channel reproduction, the AM/FM radio 50 reproduces the audio signal in response to the signal received from the tuner 52, and supplies it to the amplifier 51. The amplifier 51 amplifies the audio signal, and supplies it to the speaker not shown. Thus, the speaker produces sounds.

On the other hand, to perform the 5.1 channel reproduction, the AM/FM radio 50 extracts the data of the channel assigned to itself from the multichannel data transmitted via the network 70, reproduces the audio signal in response to the data of the extracted channel, and supplies it to the amplifier 51. The audio signal amplified by the amplifier 51 is supplied to the speaker not shown, which produces sounds for the front left (FL).

The PC 60 includes the amplifier 51, a hard disk 62, a monitor 63 and a keyboard 64. When not performing the 5.1 channel reproduction, the PC 60 reproduces the audio signal in response to the data stored in the hard disk 62, and supplies it to the amplifier 61. The amplifier 61 amplifies the audio signal, and supplies it to the speaker not shown, thereby producing sounds from the speaker.

On the other hand, to perform the 5.1 channel reproduction, the PC 60 extracts the data of the channel assigned to itself from the multichannel data transmitted via the network 70, and generates the audio signal in response to the data of the extracted channel, and supplies it to the amplifier 61. The amplifier 61 amplifies the audio signal, and supplies it to the speaker not shown, thereby generating sounds for the rear left (RL).

Next, the detailed configuration of the DVD player 10 serving as the head unit will be described. FIG. 2 is a block diagram showing a detailed configuration of the DVD player 10. The DVD player 10 includes the amplifier 11, the DVD drive 12, a network interface 13, a channel extractor 14, a channel decider 15, an audio reproduction competence data memory 16, a work memory 17 and the speaker 18.

When not performing the 5.1 channel reproduction, the amplifier 11 amplifies the audio signal fed from the DVD drive 12, and supplies it to the speaker 18. On the other hand, to perform the 5.1 channel reproduction, it amplifies the extracted channel signal fed from the channel extractor 14, and supplies it to the speaker 18.

The DVD drive 12 functions as a sound source. As described above, when not performing the 5.1 channel reproduction, it generates the video and audio signals in response to the data read from the DVD inserted. The video signal generated by the DVD drive 12 is supplied to a monitor not shown. The audio signal generated by the DVD drive 12 is amplified by the amplifier 11, and is supplied to the speaker 18. On the other hand, to perform the 5.1 channel reproduction, the DVD drive 12 reads the multichannel data from the inserted DVD, and supplies it to the network interface 13.

The network interface 13 transmits the multichannel data from the DVD drive 12 to the network 70, and also supplies the data to the channel extractor 14. In addition, the network interface 13 transfers control data from the channel decider 15 to the network 70, receives control data from the network 70, and supplies it to the channel decider 15.

The channel extractor 14 extracts the data of the channel assigned to itself, from the multichannel data transmitted from the DVD drive 12 via the network interface 13 in response to a selection signal from the channel decider 15, and supplies it to the amplifier 11 as the extracted channel signal.

The audio reproduction competence data memory 16 consists of a read-only memory (ROM), for example, and stores the audio reproduction competence data. The audio reproduction competence data includes data representing reproduction frequency characteristics and amplification competence of the amplifier 11. The audio reproduction competence data stored in the audio reproduction competence data memory 16 is read by the channel decider 15.

The channel decider 15 stores in the work memory 17 the audio reproduction competence data read from the audio reproduction competence data memory 16, and the audio reproduction competence data acquired from the slave units via the network 70 and network interface 13. Then, according to the audio reproduction competence data of all the units stored in the work memory 17, the channel decider 15 assigns the channels to the individual units. The selection signal representing the assigned channels is supplied to the channel extractor 14, and is transmitted to the individual slave units via the network interface 13 and network 70 as the control data.

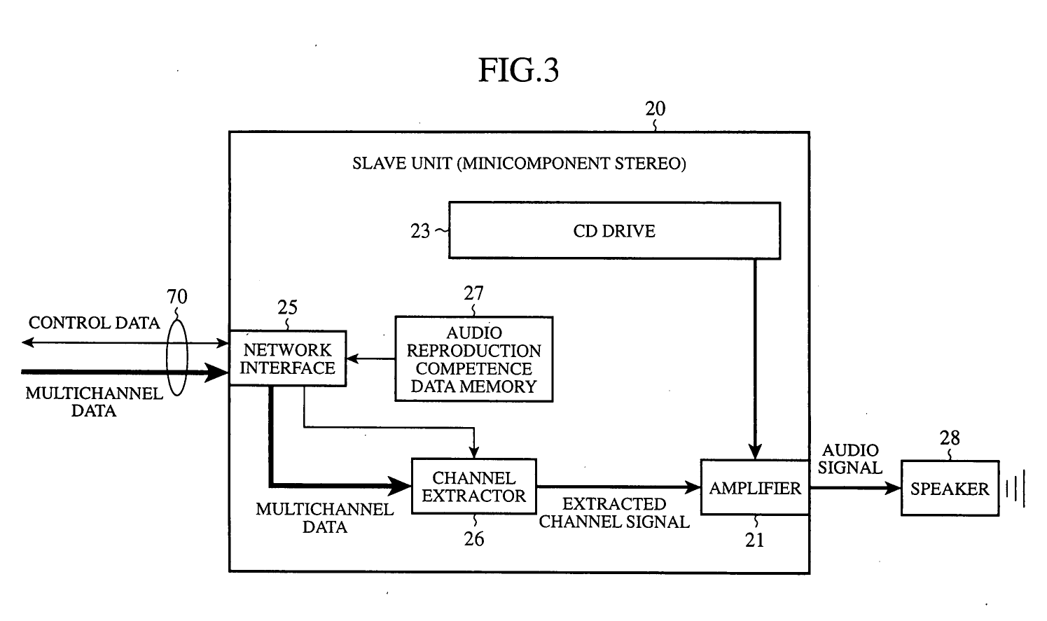

Next, the details of the slave units will be described. Since the configurations of the individual slave units for the 5.1 channel reproduction are the same, they will be described by way of example of the minicomponent stereo 20. FIG. 3 is a block diagram showing a configuration of a section using the CD drive 23 as the sound source in the minicomponent stereo 20 operating as one of the slave units.

The minicomponent stereo 20 includes the amplifier 21, the CD drive 23, a network interface 25, a channel extractor 26, an audio reproduction competence data memory 27 and a speaker 28.

As described above, when not performing the 5.1 channel reproduction, the amplifier 21 amplifies the audio signal fed from the CD drive 23, and supplies it to the speaker 28. On the other hand, to perform the 5.1 channel reproduction, the amplifier 21 amplifies the extracted channel signal fed from the channel extractor 14, and supplies it to the speaker 28.

As described above, when not performing the 5.1 channel reproduction, the CD drive 23 generates the audio signal in response to the data read from the inserted CD. The amplifier 21 amplifies the audio signal generated by the CD drive 23, and supplies it to the speaker 28. On the other hand, to perform the 5.1 channel reproduction, the operation of the CD drive 23 is halted.

The network interface 25 supplies the channel extractor 26 with the multichannel data received from the DVD player 10 via the network 70. In addition, in response to an inquiry from the DVD player 10, the network interface 25 transmits the audio reproduction competence data stored in the audio reproduction competence data memory 27 to the DVD player 10 via the network 70 as the control data. In addition, the network interface 25 supplies the channel extractor 26 with the selection signal transmitted from the DVD player 10 via the network 70 as the control data.

The channel extractor 26 extracts the data of the channel assigned to itself from the multichannel data transmitted from the DVD player 10 via the network interface 25 according to the selection signal from the network interface 25, and supplies it to the amplifier 21 as the extracted channel signal.

The audio reproduction competence data memory 27 consists of a read-only memory (ROM), for example, and stores the audio reproduction competence data. The audio reproduction competence data includes the data representing the reproduction frequency characteristics and amplification competence of the amplifier 21. The DVD player 10 reads the audio reproduction competence data stored in the audio reproduction competence data memory 27 via the network 70 and network interface 25.

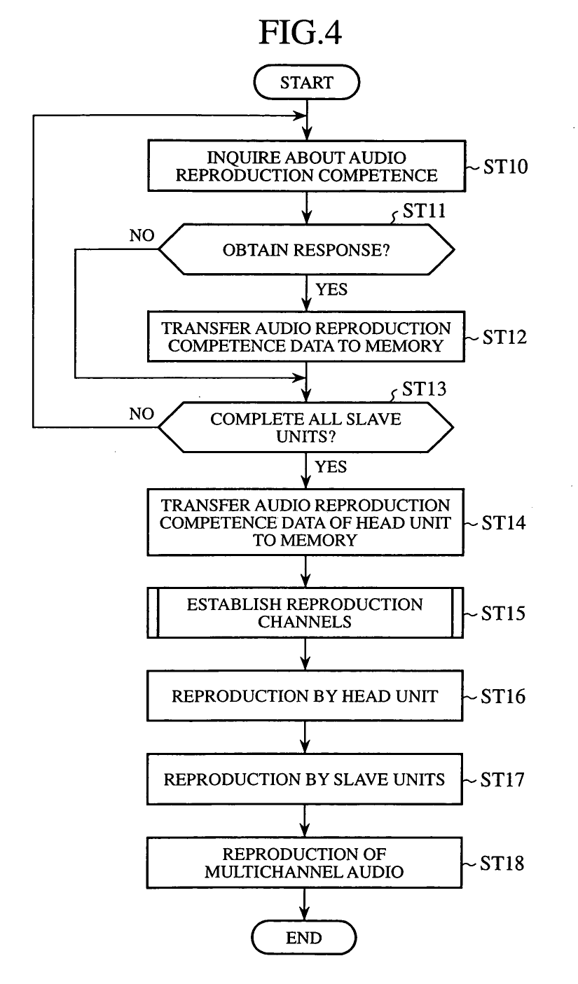

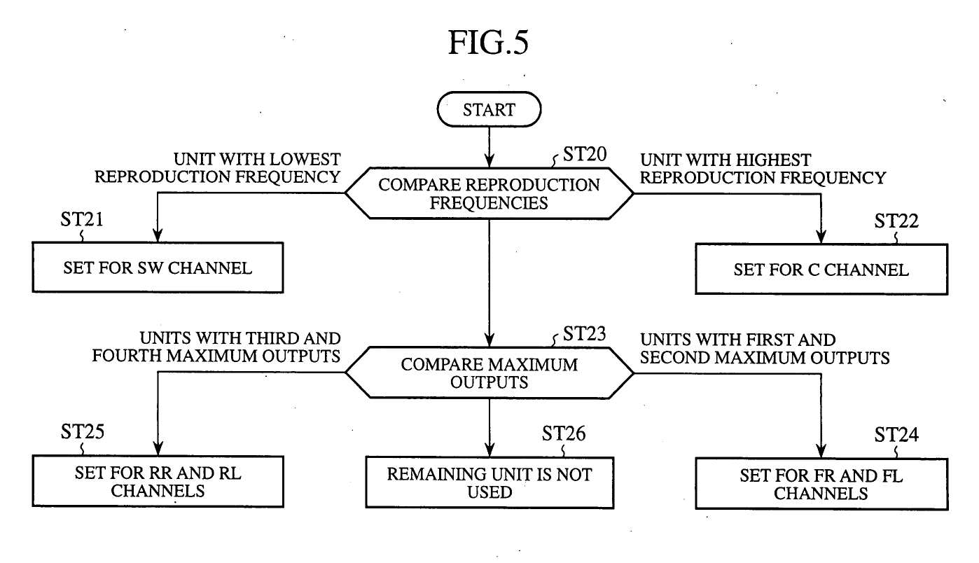

Next, the operation of the embodiment 1 of the multichannel audio system with the foregoing configuration in accordance with the present invention will be described with reference to the flowcharts as shown in FIGS. 4 and 5.

First, when the DVD player 10, the head unit, is turned on, the channel decider 15 makes an inquiry about the audio reproduction competence of the amplifier 21 of the minicomponent stereo 20, the first slave unit (step ST10). More specifically, the channel decider 15 transmits an inquiring command to the minicomponent stereo 20 via the network interface 13 and network 70. Receiving the inquiring command, the network interface 25 of the minicomponent stereo 20 reads the audio reproduction competence data of the amplifier 21 stored in the audio reproduction competence data memory 27, and transmits the data to the DVD player 10 via the network 70.

The DVD player 10 checks as to whether the minicomponent stereo 20 sends a reply, that is, whether the DVD player 10 receives the audio reproduction competence data (step ST11). When it makes a decision that it receives the audio reproduction competence data, it transfers the received audio reproduction competence data to the work memory 17 (step ST12). On the other hand, when it makes a decision that it has not yet received the audio reproduction competence data, it skips the transfer of step ST12.

Subsequently, the channel decider 15 of the DVD player 10 checks as to whether the inquiries about all the slave units have been completed or not (step ST13). When it makes a decision that not all the inquiries have been completed, the channel decider 15 returns the sequence to step ST10 where it makes the inquiry about the audio reproduction competence of the amplifier 22 of the minicomponent stereo 20, and acquires the audio reproduction competence data. Likewise, the channel decider 15 sequentially makes the inquiry about the audio reproduction competence of the TV set 30, portable MP3 player 40, AM/FM radio 50 and PC 60, which are the slave units, and acquires their audio reproduction competence data.

When it makes a decision that the inquiries about all the slave units have been completed at step ST13, the channel decider 15 of the DVD player 10 reads the audio reproduction competence data from its audio reproduction competence data memory 16, and transfers the data to the work memory 17 (step ST14). Thus, the audio reproduction competence data of all the units constituting the multichannel audio system are stored in the work memory 17.

Subsequently, the channel decider 15 of the DVD player 10 carries out the reproduction channel establishment processing (step ST15), the detail of which will be described with reference to the flowchart of FIG. 5.

In the reproduction channel establishment processing, the channel decider 15 refers to the reproduction frequency characteristics in the audio reproduction competence data of the individual units stored in the work memory 17, and compares the reproduction frequencies, first (step ST20). As a result of the comparison, the channel decider 15 decides the unit with the lowest reproduction frequency, and sets the unit to operate as the reproduction channel for the sub-woofer (SW) (step ST21) More specifically, as illustrated in FIG. 1, when it decides that the reproduction frequency of the amplifier 21 in the minicomponent stereo 20 is lowest, the channel decider 15 transmits the selection signal to the minicomponent stereo 20 via the network interface 13 and network 70 as the control data. Receiving the selection signal transmitted from the network 70 as the control data, the network interface 25 of the minicomponent stereo 20 supplies it to the channel extractor 26. In response to the selection signal, the channel extractor 26 is set in such a manner that it extracts the data for the sub-woofer from the multichannel data transmitted from the network 70 via the network interface 25. Thus, the amplifier 21 of the minicomponent stereo 20 is set to operate as the reproduction channel for the sub-woofer (SW).

According to the results of the comparison at step ST20, the channel decider 15 decides the unit with the highest reproduction frequency, and sets it to operate as the reproduction channel for the center (C) in the same manner as described above (step ST22). In the example as shown in FIG. 1, the amplifier 31 of the TV set 30 is set to operate as the reproduction channel for the center (C).

Referring to the amplification competence in the audio reproduction competence data of the individual units stored in the work memory 17, the channel decider 15 compares the maximum outputs between the units having the reproduction frequencies other than those mentioned above (step ST23). According to the results of the comparison, the channel decider 15 decides the units with the first and second maximum outputs, and sets them to reproduce the channel for the front right (FR) and the channel for the front left (FL), respectively (step ST24). In the example as shown in FIG. 1, the amplifier 22 of the minicomponent stereo 20 is set to operate as the reproduction channel for the front right (FR), and the amplifier 51 of the AM/FM radio 50 is set to operate as the reproduction channel for the front left (FL).

According to the results of the comparison at step ST23, the channel decider 15 decides the units with the third and fourth maximum outputs, and sets them to reproduce the channel for the rear right (RR) and the channel for the rear left (RL), respectively (step ST25). In the example as shown in FIG. 1, the amplifier 11 of the DVD player 10 is set to operate as the reproduction channel for the rear right (RR), and the amplifier 61 of the PC 60 is set to operate as the reproduction channel for the rear left (RL). Incidentally, as for the channel extractor 14 of the DVD player 10, the head unit, the channel decider 15 transfers the selection signal directly to it.

As a result of the comparison at step ST23, the unit having the maximum output other than those mentioned above is not used as a component constituting the multichannel audio system (step ST26). In the example as shown in FIG. 1, the portable MP3 player 40 is not used. Completing the unit assignment to all the channels (six channels), the sequence is returned to step ST16 of the flowchart as shown in FIG. 4.

Completing the reproduction channel establishment processing at step ST15, the head unit (DVD player 10), the sound source, starts the reproduction (step ST16). More specifically, the data read from the DVD inserted into the DVD drive 12 is transmitted to the network 70 via the network interface 13 as the multichannel data, and is also supplied to the channel extractor 14. The channel extractor 14 extracts the data of the channel assigned to itself from the multichannel data (the data for the rear right (RR)), and supplies it to the amplifier 11 as the extracted channel signal. The amplifier 11 amplifies the extracted channel signal, and supplies it to the speaker 18 as the audio signal. Thus, the speaker 18 produces the sounds for the rear right (RR).

Subsequently, the individual slave units carry out their reproduction (step ST17). More specifically, the channel extractors of the individual slave units extract the data assigned to them from the multichannel data transmitted from the network 70 via the channel interface, amplify the extracted data by the amplifiers, and supply them to the speakers. Thus, the speakers produce the sounds of the channels assigned to the individual slave units.

As described above, the audio sounds of the channels assigned to the individual units are produced simultaneously, thereby carrying out the reproduction of the 5.1 channel sounds (step ST18).

As described above, the embodiment 1 of the multichannel audio system in accordance with the present invention, which includes six or more slave units, can perform the 5.1 channel sound reproduction, and make effective use of the plurality of units on the network 70 by optimizing them for the multichannel reproduction. In addition, although it has no amplifiers for the multichannel reproduction, it can carry out the multichannel reproduction efficiently by utilizing the monaural and stereo amplifiers, thereby being able to reduce the cost, save the space, decrease the amount of the wiring and improve the sound quality.

Although the embodiment 1 uses the DVD player 10 as the head unit to configure the multichannel audio system, the head unit is not limited to the DVD player 10, but a variety of types of units can be used as the head unit as long as they constitute a sound source.

Embodiment 2

The embodiment 2 of the multichannel audio system in accordance with the present invention is configured such that it can vary the frequency characteristics of the individual channels.

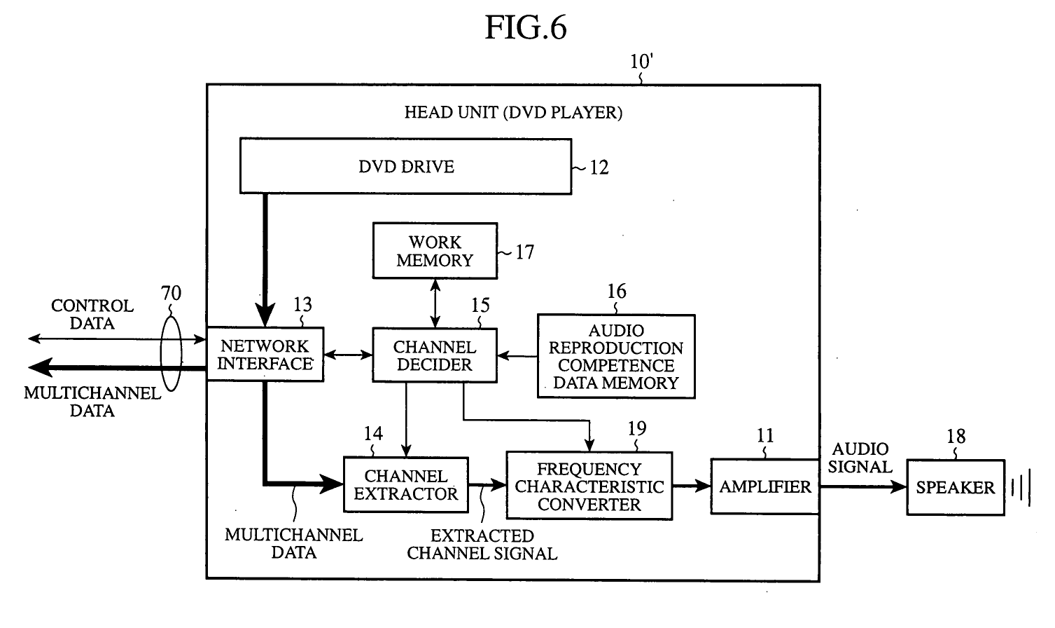

FIG. 6 is a block diagram showing a detailed configuration of a DVD player 10′ which is used as the head unit of the foregoing embodiment 1 of the multichannel audio system in accordance with the present invention. The DVD player 10′ includes, in addition to the DVD player 10 of the embodiment 1 as shown in FIG. 2, a frequency characteristic converter 19 interposed between the channel extractor 14 and the amplifier 11.

The frequency characteristic converter 19 varies the frequency characteristics of the extracted channel signal output from the channel extractor 14, that is, the levels in a specific frequency band, in response to a range control signal from the channel decider 15, and supplies the varied frequency characteristics to the amplifier 11. Thus, the frequency characteristic converter 19 makes it possible to vary the output levels of low-, mid- and high-frequency ranges.

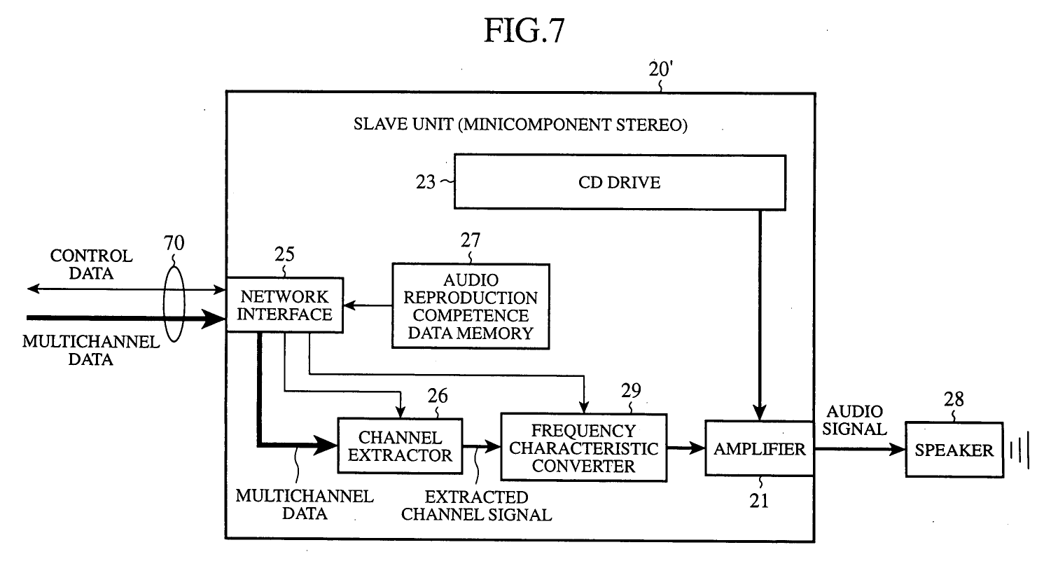

FIG. 7 is a block diagram showing a detailed configuration of a part of the minicomponent stereo 20′ which is used as the slave unit of the embodiment 1 of the multichannel audio system in accordance with the present invention, which part uses the CD drive 23 as the sound source. The minicomponent stereo 20′ includes, in addition to the minicomponent stereo 20 of the embodiment 1 as shown in FIG. 3, a frequency characteristic converter 29 interposed between the channel extractor 26 and the amplifier 21.

The frequency characteristic converter 29 varies the frequency characteristics of the extracted channel signal output from the channel extractor 26, that is, the levels of a specific frequency band, in response to a range control signal from the network interface 25, and supplies the varied frequency characteristics to the amplifier 21. Thus, the frequency characteristic converter 29 makes it possible to vary the output levels of low-, mid- and high-frequency ranges. Although not shown in the drawings, the remaining slave units each include a frequency characteristic converter as well.

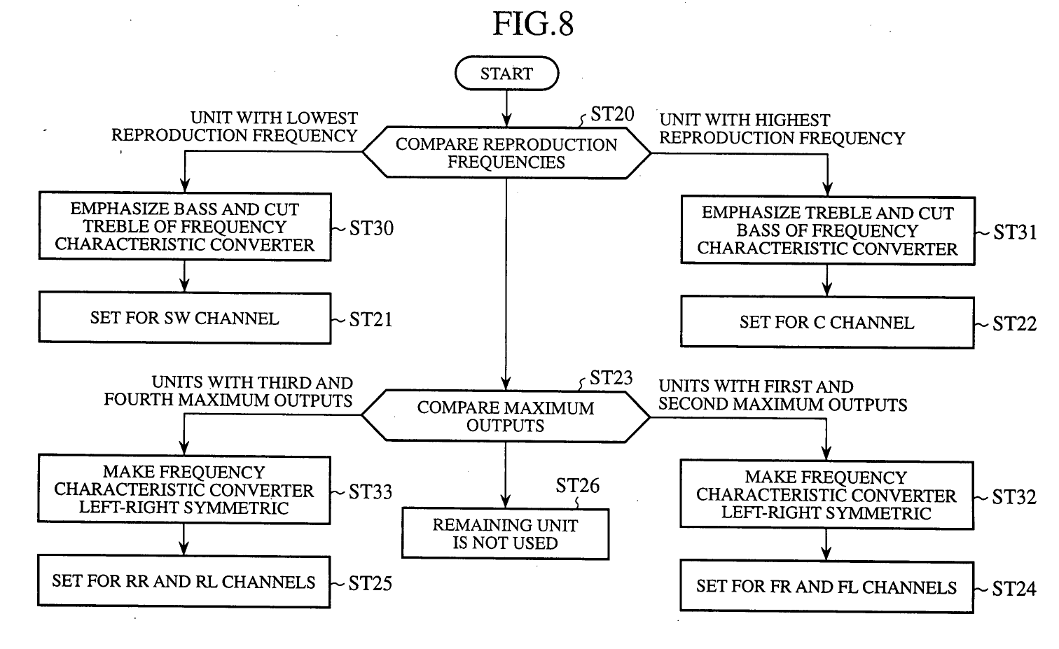

The settings of the additional frequency characteristic converters 19 and 29 in the present embodiment 2 are carried out by the reproduction channel establishment processing described above. FIG. 8 is a flowchart illustrating the reproduction channel establishment processing of the present embodiment 2. It differs from that of the embodiment 1 in that it includes additional steps ST30-ST33 for setting the frequency characteristic converters 19 and 29.

In the reproduction channel establishment processing, the channel decider 15 of the DVD player 10′ refers to the audio reproduction competence data of the individual units stored in the work memory 17, and compares the reproduction frequencies, first (step ST20). As a result of the comparison, the channel decider 15 decides the unit with the lowest reproduction frequency, and sets the frequency characteristic converter 19 or 29 of that unit such that it emphasizes the bass and cuts the treble (step ST30). More specifically, as illustrated in FIG. 1, when it decides that the reproduction frequency of the amplifier 21 in the minicomponent stereo 20 is lowest, the channel decider 15 transmits the range control signal to the minicomponent stereo 20 via the network interface 13 and network 70 as the control data. Receiving the range control signal transmitted from the network 70 as the control data, the network interface 25 of the minicomponent stereo 20 supplies it to the frequency characteristic converter 29. Thus, the frequency characteristic converter 29 is set such that it emphasizes the low frequency region and cuts the high frequency region of the extracted channel signal fed from the channel extractor 26.

Subsequently, the unit that is decided to have the lowest reproduction frequency is set to operate as the reproduction channel for the sub-woofer (SW) (step ST21). More specifically, as illustrated in FIG. 1, when the channel decider 15 decides that the reproduction frequency of the amplifier 21 in the minicomponent stereo 20 is lowest, it transmits the selection signal to the minicomponent stereo 20 via the network interface 13 and network 70 as the control data. Receiving the selection signal transmitted from the network 70 as the control data, the network interface 25 of the minicomponent stereo 20 supplies it to the channel extractor 26. The channel extractor 26 is set in such a manner that it extracts the data for the sub-woofer from the multichannel data transmitted from the network 70 via the network interface 25, and supplies the data to the frequency characteristic converter 29. Thus, the amplifier 21 of the minicomponent stereo 20 is set to operate as the reproduction channel for the sub-woofer (SW).

According to the results of the comparison at step ST20, the channel decider 15 decides the unit with the highest reproduction frequency, and sets the frequency characteristic converter 19 or 29 of that unit such that it cuts the bass and emphasizes the treble (step ST31). In the example as shown in FIG. 1, the frequency characteristic converter of the TV set 30 is set such that it cuts the bass and emphasizes the treble.

Subsequently, the unit that is decided to have the highest reproduction frequency is set to operate as the reproduction channel for the center (C) in the same manner as described above (step ST22). In the example as shown in FIG. 1, the amplifier 31 of the TV set 30 is set to operate as the reproduction channel for the center (C).

Referring to the audio reproduction competence data of the individual units stored in the work memory 17, the channel decider 15 compares the maximum outputs between the units having the reproduction frequencies other than those mentioned above (step ST23). According to the results of the comparison, the channel decider 15 decides the units with the first and second maximum outputs, and sets the frequency characteristic converters 19 or 29 of those units such that they have left-right symmetry in the frequency characteristics (step ST32). In the example as shown in FIG. 1, the frequency characteristics of the amplifier 22 of the minicomponent stereo 20 and the frequency characteristics of the amplifier 51 of the AM/FM radio 50 are set to be symmetrical.

Subsequently, the units that is decided to have the first and second maximum outputs are set to reproduce the channel for the front right (FR) and the channel for the front left (FL), respectively (step ST24). In the example as shown in FIG. 1, the amplifier 22 of the minicomponent stereo 20 is set to operate as the reproduction channel for the front right (FR), and the amplifier 51 of the AM/FM radio 50 is set to operate as the reproduction channel for the front left (FL).

According to the results of the comparison at step ST23, the channel decider 15 decides the units with the third and fourth maximum outputs, and sets the frequency characteristic converters 19 or 29 of those units such that they have left-right symmetry in the frequency characteristics (step ST33). In the example as shown in FIG. 1, the frequency characteristics of the amplifier 11 of the DVD player 10 and the frequency characteristics of the amplifier 61 of the PC 60 are set to be symmetrical. Incidentally, as for the frequency characteristic converter 19 of the DVD player 10′, the head unit, the channel decider 15 transfers the range control signal directly to the frequency characteristic converter 19.

Subsequently, the units that are decided to have the third and fourth maximum outputs are set to reproduce the channel for the rear right (RR) and the channel for the rear left (RL), respectively (step ST25). In the example as shown in FIG. 1, the amplifier 11 of the DVD player 10 is set to operate as the reproduction channel for the rear right (RR), and the amplifier 61 of the PC 60 is set to operate as the reproduction channel for the rear left (RL). Incidentally, as for the channel extractor 14 of the DVD player 10′, the head unit, the channel decider 15 transfers the selection signal directly to the channel extractor 14.

As a result of the comparison at step ST23, the unit having the maximum output other than those mentioned above is not used as a component constituting the multichannel audio system (step ST26). In the example as shown in FIG. 1, the portable MP3 player 40 is not used. Completing the unit assignment to all the channels (six channels), the sequence is returned to step ST16 of the flowchart as shown in FIG. 4.

As described above, the embodiment 2 of the multichannel audio system in accordance with the present invention is configured such that it can convert the frequency characteristics of the individual channels with the frequency characteristic converter 19 or 29. Thus, it can generate sounds with ideal frequency characteristics through the individual channels. Specifically, the unit for the reproduction channel of the sub-woofer (SW) emphasizes the bass, the unit for the reproduction channel of the center (C) emphasizes the treble, and the units for the front right (FR) and front left (FL), and the units for the rear right (RR) and rear left (RL) are adjusted to have left-right symmetry. Thus, the present embodiment 2 can optimize the reproduction environment of the multichannels (5.1 channels).

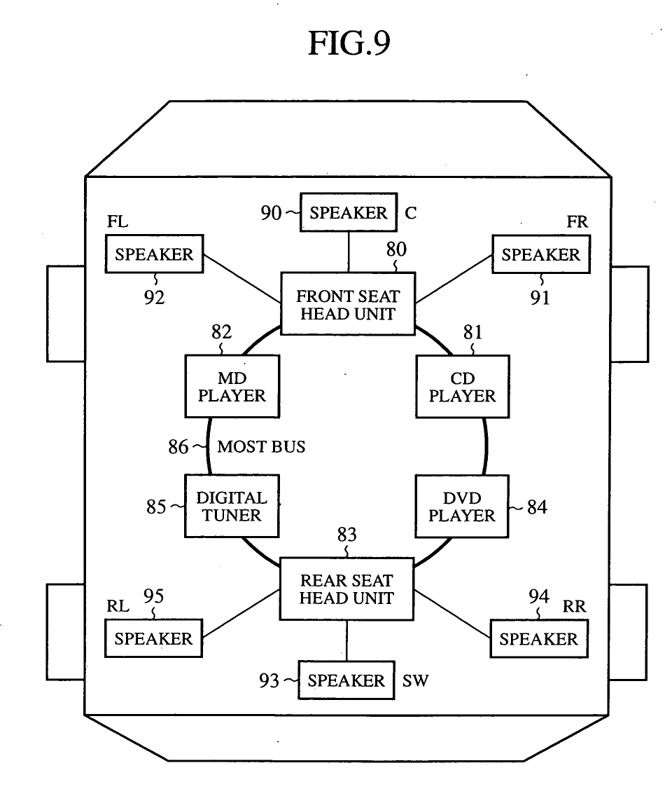

Next, an application of the multichannel audio system in accordance with the present invention will be described. FIG. 9 shows an application of the multichannel audio system in accordance with the present invention to a vehicle to carry out the 5.1 channel reproduction.

The multichannel audio system includes a front seat head unit 80, a CD player 81, an MD player 82, a rear seat head unit 83, a DVD player 84 and a digital tuner 85, and a MOST (Media Oriented System Transport) bus 86 interconnecting these six units. The front seat head unit 80 is connected to a center (C) speaker 90, a front right (FR) speaker 91 and a front left (FL) speaker 92. The rear seat head unit 83 is connected to a sub-woofer (SW) speaker 93, a rear right (RR) speaker 94 and a rear left (RL) speaker 95.

Although the detail configurations of the individual units are omitted, one of the six units has the configuration of the head unit of the embodiment 1 or 2, and the remaining units have the configurations of the slave units.

Applying the multichannel audio system in accordance with the present invention to a vehicle makes it possible to distribute the amplifier units to optimum positions. Consequently, a system can be configured with short speaker wiring, which has advantages in space efficiency, cost, sound quality and noise. In particular, when an RSE (rear seat entertainment) including a plurality of front seat and rear seat amplifiers is mounted, a system can be constructed which can make effective use of these units.

What is claimed is:

1. A multichannel audio system including a head unit for transmitting multichannel data, slave units for receiving the multichannel data, and a network for connecting the head unit and the slave units, wherein
said head unit assigns a channel and transmits multichannel data to each of said slave units; and
said slave units each generate an audio signal in response to data of a channel assigned by said head unit, the data of the channel being extracted from the multichannel data received from said head unit.

2. The multichannel audio system according to claim 1, wherein said head unit comprises:
a sound source for generating multichannel data;
a network interface for transmitting the multichannel data generated by said sound source to the network;
a channel decider for assigning the channel to each of said slave units and to said head unit;
a channel extractor for extracting data of the channel assigned by said channel decider from the multichannel data generated by said sound source; and
an amplifier for amplifying the extracted channel signal obtained by said channel extractor.

3. The multichannel audio system according to claim 2, wherein said channel decider assigns the channel in response to audio reproduction competence data representing audio reproduction competence of said slave units and said head unit.

4. The multichannel audio system according to claim 2, wherein said head unit further comprises a frequency characteristic converter for converting frequency characteristics of the extracted channel signal obtained by said channel extractor.

5. The multichannel audio system according to claim 1, wherein said slave units each comprise:
a channel extractor for extracting data of the channel assigned by said channel decider from the multichannel data transmitted from said head unit via said network; and
an amplifier for amplifying an extracted channel signal obtained by said channel extractor.

6. The multichannel audio system according to claim 5, wherein said slave units each comprise a frequency characteristic converter for converting frequency characteristics of the extracted channel signal obtained by said channel extractor.

7. A head unit comprising:
a sound source for generating multichannel data;
a network interface for transmitting the multichannel data generated by said sound source to a network;
a channel decider for assigning a channel to each of said slave units and to said head unit which are connected to the network;
a channel extractor for extracting data of the channel assigned by said channel decider from the multichannel data generated by said sound source; and
an amplifier for amplifying the extracted channel signal obtained by said channel extractor.

8. The head unit according to claim 7, wherein said channel decider assigns the channel in response to audio reproduction competence data representing audio reproduction competence of said slave units and said head unit which are connected to the network.

9. The head unit according to claim 8, further comprising a frequency characteristic converter for converting frequency characteristics of the extracted channel signal obtained by said channel extractor.

10. A slave unit comprising:
a channel extractor for extracting data of a preassigned channel from multichannel data transmitted from a network; and
an amplifier for amplifying an extracted channel signal obtained by said channel extractor.

11. The slave unit according to claim 10, further comprising a frequency characteristic converter for converting frequency characteristics of the extracted channel signal obtained by said channel extractor.
